(19) United States
(12) Patent Application Publication
(10) Pub. No.: US 2020/0353386 A1
(43) Pub. Date: Nov. 12, 2020

(54) FILTER FOR LIQUID FILTRATION

(71) Applicant: ZHEJIANG WEITAI AUTOMOBILE PARTS CO., LTD., Huzhou City (CN)

(72) Inventors: Jianbin Cheng, Huzhou City (CN); Yu Zhang, Huzhou City (CN); Qinglin Den, Huzhou City (CN); Guixiang Zhu, Huzhou City (CN)

(21) Appl. No.: 16/572,549

(22) Filed: Sep. 16, 2019

(30) Foreign Application Priority Data
May 8, 2019 (CN) 201910379658.0

(51) Int. Cl. B01D 29/96; B01D 29/11

(52) U.S. Cl. CPC B01D 29/96; B01D 29/11; B01D 2201/4076; B01D 2201/305; B01D 2201/295

(57) ABSTRACT

The present invention relates to the field of liquid filtration, in particular, to a filter suitable for liquid filtration. The present invention is achieved by the following technical solutions: a filter suitable for liquid filtration comprises a cartridge body, the cartridge body being detachably connected with a closure cover, the cartridge body and the closure cover together constituting a receiving cavity for receiving a filter element, and further comprises a fixing device for fixing the closure cover to the cartridge body. An object of the present invention is to provide a filter suitable for liquid filtration, wherein the filter cartridge is provided with a detachably mounted upper cover, so that the two parts of the filter cartridge do not damage the filter element therein during the friction welding process, and the filter element may be replaced and mounted conveniently and reliably.

### FIELD OF THE APPLICATION

The present invention relates to the field of liquid filtration, in particular, to a filter suitable for liquid filtration.

### BACKGROUND OF THE APPLICATION

Liquid filtration is a workflow that ensures the quality of liquids, and is widely used in various industrial fields. Taking fuel filtration as an example, in motor vehicles, various fuel filter elements are often required to ensure the quality of the engine. The high-quality filter element effectively blocks the dust and moisture entrained in gasoline and diesel, and effectively extends the service life of the fuel injection pump, fuel nozzles and other filter elements and ensures the safety of use.

In the prior art, motor vehicles often use a filter element assembly as disclosed in the Chinese Patent Publication No. CN207620950, which comprises a filter cartridge and a filter element disposed in the filter cartridge, the filter cartridge being provided with an oil inlet and an oil outlet. The fuel enters from the oil inlet, is filtered on the filter element and exits the oil outlet to complete the filtration cycle for improving fuel quality

However, this structure has certain drawbacks. The filter element is mounted in the filter cartridge, and then the upper and lower cylinder portions of the filter cartridge are welded, for example, using a friction welding process. In this process, on the one hand, friction welding has higher requirements on the precision of the process equipment, which increases the purchase and maintenance cost of the equipment. On the other hand, the torsion generated by the upper and lower cartridge portions during friction welding acts on the filter element, thereby causing damage or destruction to the filter element.

### SUMMARY OF THE APPLICATION

An object of the present invention is to provide a filter for liquid filtration, wherein the filter cartridge is provided with a detachably mounted upper cover, so that the two parts of the filter cartridge do not damage the filter element therein during the friction welding process, and the filter element may be replaced and mounted conveniently and reliably.

The above technical object of the present invention is achieved by the following technical solutions: a filter suitable for liquid filtration comprises a cartridge body, the cartridge body being detachably connected with a closure cover, the cartridge body and the closure cover together constituting a receiving cavity for receiving a filter element, and further comprises a fixing device for fixing the closure cover to the cartridge body.

Preferably, the fixing device includes a plurality of clamping sets fixed on the cartridge body, and each of the clamping sets is provided with an upper clip and a lower clip; the closure cover is located between the upper clip and the lower clip in a height direction, and the closure cover is provided with a passage opening for the upper clip to pass through.

Preferably, each of the clamping sets includes an upper clip and two lower clips, and the upper clip is located between the two lower clips in the horizontal direction.

Preferably, the fixing device includes a thickening tab, the thickening tab being located on an upper surface of the closure cover.

Preferably, a lower surface of the closure cover is provided with a limiting tab for restricting the relative position of the thickening tab relative to the upper clip.

Preferably, there are two limiting tabs: a front tab and a rear tab, in order according to the forward and rearward rotating directions of the closure cover; limiting regions are defined between the front tab and the rear tab, and the two lower clips are located between the limiting regions.

Preferably, the front tab is provided with a guiding slope inclinedly arranged, and the guiding slope gradually raises in a direction convex toward the lower surface of the closure cover in the direction of the rear tab.

Preferably, the thickening tab includes inclined regions on both sides and a high-thickness region between the two inclined regions; when the two lower clips are located in the limiting regions, the abutting position of the upper clip and the thickening tab is located at the high-thickness region.

Preferably, the clamping sets are a plurality of sets, and are arranged uniformly on the closure cover in an annular array.

Preferably, the closure cover includes an outer ring, an inner ring, and a plurality of partition plates connecting the outer ring with the inner ring; the adjacent partition plates form an oil inlet region, the inner ring is provided with an oil outlet region, and the passage opening is formed at the outer ring.

In summary, the present invention has the following beneficial effects:

The cartridge body and the closure cover are separated, and high-precision processing equipment is not required in the friction welding process of the upper cartridge body and the lower cartridge body, so that damage to the filter element in this process may also be avoided.

The closure cover adopts double-layer design of inner and outer rings, and is connected by a partition plate in the middle, so that the inputting and outputting of oil is convenient and smooth, and the structural strength of the closure cover is high.

The closure cover is connected rotatably by the upper and lower clips for convenient operation.

The thickening tab increase the static friction force after the rotational connection, so that the fixing effect is reliable and stable.

The design of the double limiting tabs makes the thickening tab abut fully against the upper clip for accurate fixation.

The detachable design of the cartridge body and the closure cover is such that the filter does not need to be completely replaced as in the prior art but the closure cover is opened to replace the filter element when the filter element needs to be replaced, thereby reducing the costs in equipment usage and maintenance.

### BRIEF DESCRIPTION OF THE ACCOMPANYING DRAWINGS

FIG. 1 is a view of Embodiment 1;

FIG. 2 is a view of FIG. 1 after taking out the closure cover;

FIG. 3 is a view of the closure cover.

In figures: 1 cartridge body, 11 upper cartridge body, 12 lower cartridge body, 2 closure cover, 21 outer ring, 22 inner ring, 23 partition plate, 24 oil inlet region, 25 oil outlet region, 26 passage opening, 3 fixing device, 31 thickening tab, 32 limiting tab, 321 front tab, 3211 guiding slope, 322 rear tab, 4 clamping sets, 41 upper clip, 42 lower clip.

### DETAILED DESCRIPTION OF THE PREFERRED EXAMPLES

The present invention will be further elaborated hereafter in connection with the drawings.

The specific embodiment is only illustrative of the present invention and is not a limitation of the present invention. Those skilled in the art can make modifications to the present embodiment that are not creatively contributed as needed after reading this specification, but are protected by the patent law within the scope of the claims of the present invention.

### Embodiment 1

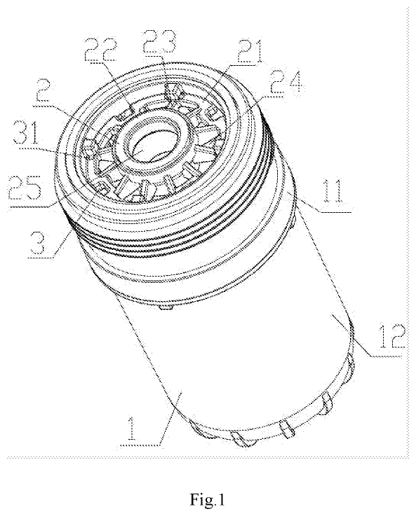

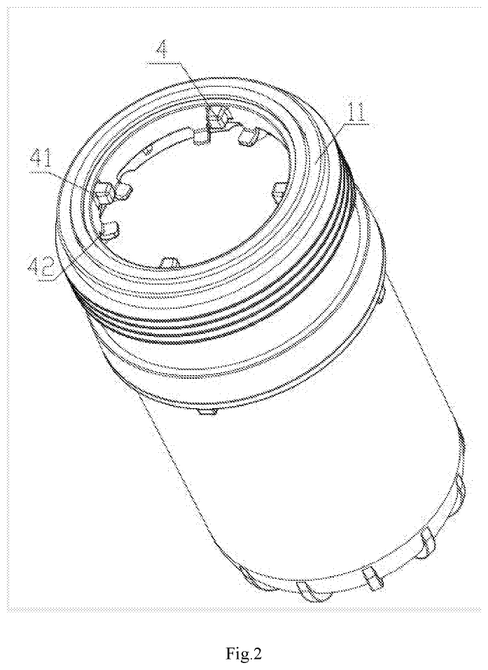

As shown in FIGS. 1 and 2, a cartridge body 1 has a cylindrical shape as a whole and is divided into two parts, an upper cartridge body 11 and a lower cartridge body 12. An upper portion of the upper cartridge body 11 is provided with an opening through which the user may insert a filter element into an inner cavity of the cartridge body 1. The user may put in and lock the closure cover 2 at the opening of the upper cartridge body 11. The upper cartridge body 11 and the lower cartridge body 12 may be connected by a friction welding process. In the process of friction welding, the user may not put the filter element into the inner cavity of the cartridge body 1 or insert the filter element into the inner cavity of the cartridge body 1 without locking the closure cover 2, and then the torque generated by the friction welding process does not cause damage to the filter element. Therefore, this process does not require high control precision of the process equipment, which reduces the cost of production and control.

In the conventional process, the upper cylinder 11 and the lower cartridge body 12 have to be friction welded together after the filter element is placed in the inner cavity of the cartridge body 1. In this way, high requirements have been proposed on the gap of the filter element from the closure cover 2 or the gap of the filter element from the lower cartridge body 12 after installation. If the distance value of the gap is not set properly, for example, if it is too small, the rotating upper cartridge body 11 or the lower cartridge body 12 may touch the filter element during welding to cause damage to the filter element. In this technical solution, the filter element may be placed after the upper cartridge body 11 and the lower cartridge body 12 are connected, and then covered with the closure cover 2, so that the filter element is not affected, and the requirements for the gap between the filter element and the cartridge body 1 is also reduced.

After the closure cover 2 is attached to the cartridge body 1, a lower end of the closure cover 2 abuts against the filter element to complete the fixation of position of the filter element in the inner cavity of the cartridge body 1. As shown in FIG. 1, the closure cover 2 includes an outer ring 21 and an inner ring 22, and a plurality of partition plates 23 are disposed between the inner ring 22 and the outer ring 21. The number of the partition plates 23 is not limited and is plural, and they are distributed in the radial direction. Each of the partitioning plates 23 divides the space between the inner ring 22 and the outer ring 21 into a plurality of oil inlet regions 24. In actual operation, the fuel enters from the oil inlet region 24, is filtered by the filter element, and exits from the oil outlet region 25 in the middle of the inner ring 22, so as to complete the filtration process.

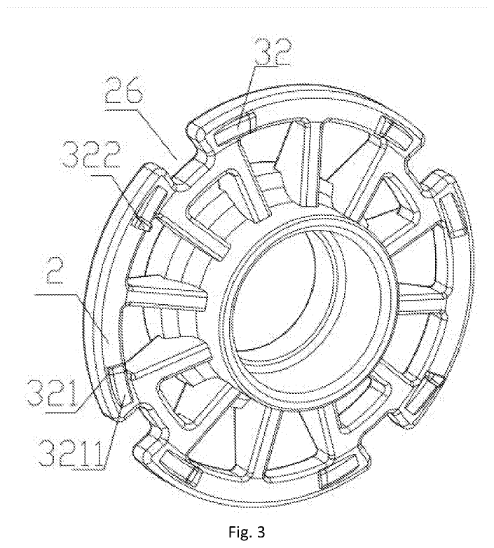

The mounting and fixing process of the closure cover 2 is completed by means of the fixing device 3, specifically, as shown in FIGS. 2 and 3. The fixing device 3 includes a plurality of clamping sets 4, and the clamping sets 4 may be a plurality of sets, both of which are disposed on an inner side wall of the upper cartridge body 11. Each of the clamping sets 4 includes an upper clip 41 and two lower clips 42. The lower clip 42 is located below the upper clip 41 in the height direction, and the upper clip 41 is between the two lower clips 42 in the horizontal direction.

A plurality of passage openings 26 are formed in the outer ring 21 of the closure cover 2, and the size and position of the passage openings 26 correspond to the upper clip 41. When mounting, the user lowers the outer ring 21. The upper clip 41 passes through the passage opening 26 to be above the closure cover 2, while the lower clip 42 is located below the closure cover 2 to support the lower surface of the closure cover 2.

Subsequently, the closure cover 2 is rotated in the horizontal direction through manual or automatic means by means of a worker or other equipment, and is fixed by the fixing device 3. The upper surface of the outer ring 21 is provided with a thickening tab 31, and the thickening tab 31 includes inclined regions on both sides and a high-thickness region between the two inclined regions. When the user rotates the closure cover 2, the high-thickness region of the thickening tab 31 enters below the upper clip 41 to abut against the lower surface of the upper clip 41 for completing the fixing of the closure cover 2 relative to the upper cartridge body 11 by static friction.

In the technical solution, a limiting design is also made by relying on the lower clip 42. Specifically, the lower surface of the outer ring 21 is provided with two limiting tabs 32, which are a front tab 321 and a rear tab 322, respectively. As mentioned above, there are also two lower clips 42. During the rotation of the closure cover 2 by the user, the first lower clip 42 slides over the front tab 321. In order to facilitate the sliding of the first lower clip 42 over the front tab 321, the front tab 321 is purposely provided with a guiding slope 3211, which is inclinedly arranged. After the first clip 42 slides over the front tab 321, it continues to slide forward and reaches the rear tab 322, and then is blocked by a blocking portion of rear tab 322 protruding from the lower surface of the closure cover 2, thereby being unable to move forward. At this time, the second clip 42 also slides over the front tab 321, and the front tab 321 also has a blocking portion protruding from the lower surface of the closure cover 2 to prevent the second clip 42 from slipping back after sliding. So far, a limiting region is formed between the front tab 321 and the rear tab 322 to limit the two clips 42 in the limiting region. When the two lower clips 42 are located in the limiting region, the abutting position of the upper clip 41 and the thickening tab 31 is located at the position of the high-thickness region, and the fixing effect of the closure cover 2 is good.

Since various components on the closure cover 2 have certain elasticity, the clip 4 may slide over the limiting region as long as a large force is applied, thereby removing the entire closure cover 2. In the prior art, if the service life of the filter element is reached, the entire filter must be replaced. However, in this technical solution, the above object may be achieved only by replacing the filter element through removing the closure cover 2 while retaining the cartridge body 1 and the closure cover 2, which further reduces the maintenance cost and the use cost.

What is claimed is:

1. A filter for liquid filtration, comprising a cartridge body (1), characterized in that the cartridge body (1) is detachably connected with a closure cover (2), the cartridge body (1) and the closure cover (2) together constitute a receiving cavity for receiving a filter element, and the filter further comprises a fixing device (3) for fixing the closure cover (2) to the cartridge body (1).

2. The filter for liquid filtration according to claim 1, characterized in that: the fixing device (3) includes a plurality of clamping sets (4) fixed on the cartridge body (1), and each of the clamping sets (4) is provided with an upper clip (41) and a lower clip (42); the closure cover (2) is located between the upper clip (41) and the lower clip (42) in a height direction, and the closure cover (2) is provided with a passage opening (26) for the upper clip (41) to pass through.

3. The filter for liquid filtration according to claim 2, characterized in that each of the clamping sets (4) includes an upper clip (41) and two lower clips (42), and the upper clip (41) is located between the two lower clips (42) in the horizontal direction.

4. The filter for liquid filtration according to claim 3, characterized in that the fixing device (3) includes a thickening tab (31), the thickening tab (31) being located on an upper surface of the closure cover (2).

5. The filter for liquid filtration according to claim 4, characterized in that a lower surface of the closure cover (2) is provided with a limiting tab (32) for restricting the relative position of the thickening tab (31) relative to the upper clip (41).

6. The filter for liquid filtration according to claim 5, characterized in that there are two limiting tabs (32): a front tab (321) and a rear tab (322), in order according to the forward and rearward rotating directions of the closure cover (2); limiting regions are defined between the front tab (321) and the rear tab (322), and the two lower clips (42) are located between the limiting regions.

7. The filter for liquid filtration according to claim 6, characterized in that: the front tab (321) is provided with a guiding slope (321) inclinedly arranged, and the guiding slope (321) gradually raises in a direction convex toward the lower surface of the closure cover (2) in the direction of the rear tab (322).

8. The filter for liquid filtration according to claim 6, characterized in that the thickening tab (31) includes inclined regions on both sides and a high-thickness region between the two inclined regions; when the two lower clips (42) are located in the limiting regions, the abutting position of the upper clip (41) and the thickening tab (31) is located at the high-thickness region.

9. The filter for liquid filtration according to claim 2, characterized in that the clamping sets (4) are a plurality of sets, and are arranged uniformly on the closure cover (2) in an annular array.

10. The filter for liquid filtration according to claim 3, characterized in that the clamping sets (4) are a plurality of sets, and are arranged uniformly on the closure cover (2) in an annular array.

11. The filter for liquid filtration according to claim 4, characterized in that the clamping sets (4) are a plurality of sets, and are arranged uniformly on the closure cover (2) in an annular array.

12. The filter for liquid filtration according to claim 5, characterized in that the clamping sets (4) are a plurality of sets, and are arranged uniformly on the closure cover (2) in an annular array.

13. The filter for liquid filtration according to claim 6, characterized in that the clamping sets (4) are a plurality of sets, and are arranged uniformly on the closure cover (2) in an annular array.

14. The filter for liquid filtration according to claim 7, characterized in that the clamping sets (4) are a plurality of sets, and are arranged uniformly on the closure cover (2) in an annular array.

15. The filter for liquid filtration according to claim 2, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).

16. The filter for liquid filtration according to claim 3, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).

17. The filter for liquid filtration according to claim 4, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).

18. The filter for liquid filtration according to claim 5, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).

19. The filter for liquid filtration according to claim 6, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).

20. The filter for liquid filtration according to claim 7, characterized in that the closure cover (2) includes an outer ring (21), an inner ring (22), and a plurality of partition plates (23) connecting the outer ring (21) with the inner ring (22); the adjacent partition plates (23) form an oil inlet region (24), the inner ring (22) is provided with an oil outlet region (25), and the passage opening (26) is formed at the outer ring (21).
